(19) United States
(12) Patent Application Publication
(10) Pub. No.: US 2007/0058254 A1
(43) Pub. Date: Mar. 15, 2007

(54) Advertising sheet using micro-prism retroreflective sheet and method for manufacturing the same

(76) Inventor: Tae Il Kim, Gwangju (KR)

Correspondence Address: IPLA P.A., 3580 WILSHIRE BLVD., 17TH FLOOR, LOS ANGELES, CA, 90010, US

(21) Appl. No.: 10/595,361

(22) PCT Filed: Sep. 3, 2004
(86) PCT No.: PCT/KR04/02232

§ 371 Date: Apr. 12, 2006

(30) Foreign Application Priority Data
Nov. 11, 2003 (KR) 10-2003-0079570
Apr. 22, 2004 (KR) 10-2004-0027711

(51) Int. Cl. G02B 5/124

(52) U.S. Cl. 359/530

(57) ABSTRACT

The present invention provides an advertising sheet using a micro-prism retroreflective sheet with a highly retroreflective property and a method for manufacturing the same. The advertising sheet (400) includes the retroreflective sheet (410) which has a micro-prism reflective surface on a lower surface thereof, and a reinforced fabric (420) which is attached to the lower surface of the retroreflective sheet. The advertising sheet (400) further includes a chemical layer (430) which is applied to an upper surface of the retroreflective sheet (410), and a printing layer (440) which is provided on the chemical layer (430). The advertising sheet (400) further includes a transparent coating film (450) covering an outer surface of the printing layer (440).

### TECHNICAL FIELD

The present invention relates, in general, to advertising sheets using reflective sheets and, more particularly, to an advertising sheet using a micro-prism retroreflective sheet with a highly retroreflective property and a method for manufacturing the same.

### BACKGROUND ART

Generally, retroreflective sheets reflect incident rays in the direction from which the rays originated unlike total reflective sheets and irregular reflective sheets. Therefore, the retroreflective sheets are used for safety bands for night visibility and traffic signs, etc. In the retroreflective sheets, glass beads or micro-prisms are used as reflective materials. Particularly, each micro-prism retroreflective sheet reflects incident rays toward the source of the rays by the refraction of the incident rays on a micro-prism reflective surface which is provided on a side of the micro-prism retroreflective sheet.

A reflective sheet having both a retroreflective function and an irregular reflective function was proposed in Korean Utility Model Registration No. 243310. FIG. 1 is a sectional view showing the construction of the conventional composite reflective sheet 100 which has both an irregular reflective surface 130 and a retroreflective surface and is disclosed in Korean U.M No. 243310. As shown in FIG. 1, the conventional composite reflective sheet 100 includes a PVC (poly vinyl chloride) fabric 110 which is made of a transparent sheet. The PVC fabric 110 includes a textured surface 120 which is a micro-prism shaped and is provided on a first surface of the PVC fabric 110. The PVC fabric 110 further includes the irregular reflective surface 130 which is provided on a second surface of the PVC fabric 110. A plurality of fine grooves 131 and 132 having different inclinations are evenly provided on the irregular reflective surface 130.

In the conventional composite reflective sheet 100, rays striking the composite reflective sheet 100 are reflected on the textured surface 120. Simultaneously, the reflected rays are irregularly reflected on the fine grooves 131 and 132. Therefore, the conventional composite reflective sheet 100 has superior night visibility.

An advertising sheet using a reflective sheet was proposed in Korean Utility Model Registration No. 258086. FIG. 2 is a perspective view of the conventional advertising board using the reflective sheet 210. FIG. 3 is a sectional view taken along the line A-A of FIG. 2. As shown in FIGS. 2 and 3, the conventional advertising board 200 includes the reflective sheet 210 which is made of an acetate film. A plurality of fine glass beads 211 is attached to a rear surface of the reflective sheet 210. The advertising board 200 further includes a printing film 220 which is attached to a front surface of the reflective sheet 210 and is made of polypropylene, polyethylene and polyethylene-terephthalate to allow a predetermined pattern to be printed on the printing film 220. On a front surface of the printing film 220, various patterns and pictures are printed using a plotter and a printer. Thereafter, a protective film 230 is attached to the front surface of the printing film 220 with various patterns and pictures, thus completing the advertising board 200.

As such, in conventional reflective sheets, the glass bead or the micro-prism is used as reflective material. Safety bands for night visibility, traffic signs and advertising boards are manufactured using conventional reflective sheets. In the conventional reflective sheet using glass beads as the reflective material, about 8,000-10,000 glass beads per 1 cm 2 are attached to the reflective sheet. However, the conventional reflective sheet with the glass beads is easily affected by water and moisture. Therefore, if water or moisture exists on the reflective sheet, a reflectance ratio of the reflective sheet is excessively reduced. Furthermore, the reflective sheet with the glass beads is problematic in that the manufacturing process thereof is complex, thus increasing the production costs. In the meantime, the conventional reflective sheet using the micro-prisms as the reflective material has about 12,000 micro-prisms per 1 cm 2. The reflective sheet with the micro-prisms is not affected by water or moisture. Therefore, even when water or moisture exists on the reflective sheet with the micro-prisms, the reflective sheet with the micro-prisms can maintain a high reflectance ratio, unlike the reflective sheet with glass beads. Furthermore, the reflective sheet with the micro-prisms is advantageous in that the manufacturing process thereof is simple, thus reducing the production costs.

However, the reflective sheet with the micro-prisms has never been used for advertising. Furthermore, a method for manufacturing an advertising sheet using the micro-prisms has not been proposed.

Disclosure of Invention

### Technical Problem

Accordingly, the present invention has been made keeping in mind the above-mentioned problems occurring in the prior art, and an object of the present invention is to provide an advertising sheet and a method for manufacturing the same, in which a micro-prism retroreflective sheet with highly retroreflective property is used for the advertising sheet, thus maintaining a superior visibility even at night, thereby enhancing advertising efficiency.

### Technical Solution

In an aspect, the present invention provides an advertising sheet, including a micro-prism retroreflective sheet having a micro-prism reflective surface on a lower surface thereof; a reinforced fabric attached to the lower surface of the micro-prism retroreflective sheet to serve as a reinforcement and to allow for a smooth reflection on the micro-prism reflective surface; and a print fabric attached to an upper surface of the micro-prism retroreflective sheet, with a printing layer, on which an advertisement is printed, provided on an outer surface of the print fabric.

In another aspect, the present invention provides an advertising sheet, including a micro-prism retroreflective sheet having a micro-prism reflective surface on a lower surface thereof; a reinforced fabric attached to the lower surface of the micro-prism retroreflective sheet to serve as a reinforcement and to allow for a smooth reflection on the micro-prism reflective surface; a chemical layer applied to an upper surface of the micro-prism retroreflective sheet to allow water-based ink to be easily fixed on the micro-prism retroreflective sheet; and a printing layer provided on the chemical layer, with an advertisement printed with the water-based ink on the printing layer.

In a further aspect, the present invention an advertising sheet, including a micro-prism retroreflective sheet having a micro-prism reflective surface on a lower surface thereof; a reinforced fabric attached to the lower surface of the micro-prism retroreflective sheet to serve as a reinforcement and to allow for a smooth reflection on the micro-prism reflective surface; and a printing layer provided on an upper surface of the micro-prism retroreflective sheet, with an advertisement printed on the printing layer with a silk ink or a solvent ink including an oil-based ink.

In yet another aspect, the present invention provides a method for manufacturing an advertising sheet, including attaching a reinforced fabric to a lower surface of a micro-prism retroreflective sheet; printing an advertisement on an upper surface of a print fabric through a photographic, offset or photogravure printing process, and drying the print fabric with the advertisement; and attaching a lower surface of the print fabric to an upper surface of the micro-prism retroreflective sheet with the reinforced fabric attached to the lower surface of the micro-prism retroreflective sheet, thus completing the advertising sheet.

In still another aspect, the present invention provides a method for manufacturing an advertising sheet, including attaching a reinforced fabric to a lower surface of a micro-prism retroreflective sheet; applying chemicals for printing to an upper surface of the micro-prism retroreflective sheet to form a chemical layer capable of allowing water-based ink to be easily fixed on the micro-prism retroreflective sheet; and printing an advertisement on the chemical layer with the water-based ink, thus completing the advertising sheet.

In still another aspect, the present invention provides method for manufacturing an advertising sheet, including attaching a reinforced fabric to a lower surface of a micro-prism retroreflective sheet; and printing an advertisement on an upper surface of the micro-prism retroreflective sheet with silk ink or solvent ink including oil-based ink, thus completing the advertising sheet.

### Advantageous Effects

The present invention provides an advertising sheet which has a retroreflective sheet, thus maintaining a superior discrimination even at night, thereby enhancing advertising efficiency. Furthermore, the advertising sheet of the present invention is useful to prevent traffic accidents and safety hazards.

In addition, the advertising sheet of the present invention allows an advertisement to be printed on an outer surface of the retroreflective sheet, thus easing the manufacturing process of the advertising sheet.

### DESCRIPTION OF DRAWINGS

The above and other objects, features and other advantages of the present invention will be more clearly understood from the following detailed description taken in conjunction with the accompanying drawings, in which:

FIG. 1 is a sectional view showing the construction of a conventional composite reflective sheet with both an irregular reflective surface and a retroreflective surface;

FIG. 2 is a perspective view of a conventional advertising sheet using a reflective sheet;

FIG. 3 is a sectional view taken along the line A-A of FIG. 2;

FIG. 4 is a perspective view of an advertising sheet using a retroreflective sheet, according to a first embodiment of the present invention;

FIG. 5 is a sectional view taken along the line B-B of FIG. 4;

FIG. 6 is a sectional view showing a structure of the retroreflective sheet of FIG. 4;

FIG. 7 is a block diagram showing a method for manufacturing the advertising sheet of FIG. 4;

FIGS. 8 and 9 are pictures comparing the advertising sheet of FIG. 4 and typical advertising sheets;

FIG. 10 is a perspective view of an advertising sheet using a retroreflective sheet, according to a second embodiment of the present invention;

FIG. 11 is a block diagram showing a method for manufacturing the advertising sheet of FIG. 10; and

FIG. 12 is a perspective view of an advertising sheet using a retroreflective sheet, according to a third embodiment of the present invention.

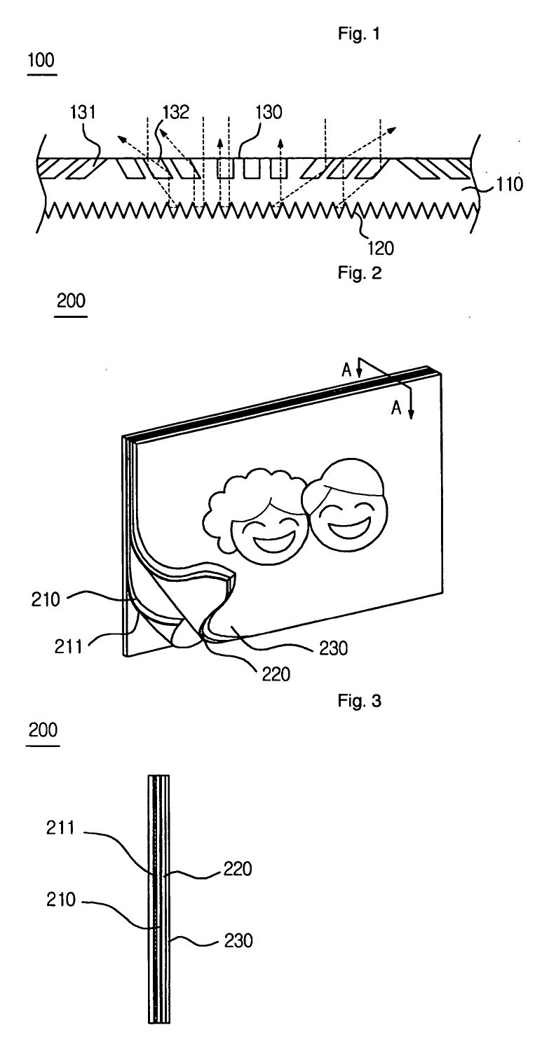

### BEST MODE

Hereinafter, embodiments of an advertising sheet using a retroreflective sheet and a method for manufacturing the same according to the present invention will be described in detail with reference to the attached drawings.

The advertising sheet of the present invention is provided by an indirect printing method in which a print fabric having a printing layer, on which an advertisement is printed through a typical printing process, is attached to an upper surface of a micro-prism retroreflective sheet. Alternatively, the advertising sheet of the present invention may be provided by a direct printing method in which the advertisement is printed on the micro-prism retroreflective sheet through the typical printing process.

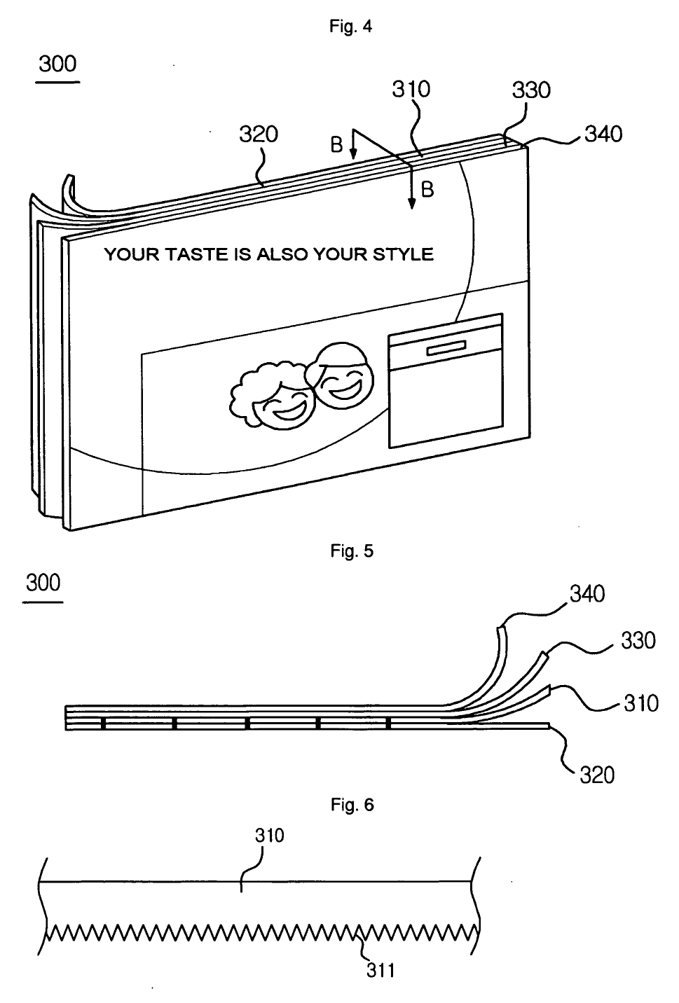

An advertising sheet 300 according to a first embodiment of the present invention is provided by the indirect printing method. FIG. 4 is a perspective view of the advertising sheet 300 using a retroreflective sheet 310, according to the first embodiment of the present invention. FIG. 5 is a sectional view taken along the line B-B of FIG. 4. FIG. 6 is a sectional view showing a structure of the retroreflective sheet 310 of FIG. 4.

As shown in FIGS. 4 and 5, the advertising sheet 300 according to the first embodiment includes the micro-prism retroreflective sheet 310 (hereinafter, referred to simply as retroreflective sheet) which has a micro-prism reflective surface 311 on a lower surface thereof. The advertising sheet 300 further includes a reinforced fabric 320 which is attached to the lower surface of the retroreflective sheet 310 to serve as a reinforcement and to allow for smooth reflection on the micro-prism reflective surface. The advertising sheet 300 further includes a print fabric 330 which is attached to an upper surface of the retroreflective sheet 310, with a printing layer, on which an advertisement is printed provided on an outer surface of the print fabric 330.

The retroreflective sheet 310 is made of a material, such as an eco-friendly material, PVC (poly vinyl chloride), PU (polyurethane), PP (polyprophylene) and PET (polyethylene terephthalate), etc. Typically, the retroreflective sheet 310 is used for a traffic sign and a safety band for night visibility. As shown in FIG. 6, the micro-prism reflective surface 311 having a retroreflective function is provided on the lower surface of the retroreflective sheet 310. About 12,000 high-brightness prisms per 1 cm 2 are arranged on the micro-prism reflective surface 311 to form a textured surface. The retroreflective sheet 310 having the above-mentioned structure forms a piece of retroreflective sheet 310 having a 45 cm width. Alternatively, the retroreflective sheet 310 may form rolls of various sizes. Therefore, in the present invention, a piece of retroreflective sheet 310, manufactured into a desired size, is directly used. Alternatively, the retroreflective sheet 310, manufactured in rolls, may be used. For example, an offset print and a photogravure print are suitable for producing a small-sized advertisement having high resolution. In this case, a piece of retroreflective sheet 310 is used. Furthermore, a photographic print using water-based ink or solvent ink including oil-based ink is suitable for producing a large-sized advertisement. In this case, the retroreflective sheet 310, wound into roll, is used.

In the present invention, the upper and lower surfaces of the retroreflective sheet 310 are preferably treated through a UV (ultra-violet) coating process to protect the micro-prism reflective surface 311, to enhance the durability of the retroreflective sheet 310, and to maintain high brightness.

The reinforced fabric 320 allows incident rays striking the retroreflective sheet 310 to reflect on the micro-prism reflective surface 311 without being absorbed. In addition, the reinforced fabric 320 has the function of reinforcing the retroreflective sheet 310. According to the purpose of the advertisement, a PVC fabric, a PVC double-sided adhesive fabric, a flax fabric, or a foamax fabric can be selectively used as the reinforced fabric 320. The reinforced fabric 320 is attached to the lower surface of the retroreflective sheet 310 through a high frequency or ultrasonic bonding process. At this time, if there is water or moisture between the retroreflective sheet 310 and the reinforced fabric 320, the light reflection cannot be smoothly executed. In due consideration of the above-mentioned disadvantage, the bonding of the reinforced fabric 320 to the lower surface of the retroreflective sheet 310 is preferably executed such that the junction parts between them forms a four-way consecutive pattern with the regular junction intervals, thus reducing loss of incident rays.

The print fabric 330 is made of a predetermined material allowing the desired advertisement to be printed on the print fabric 330 through a typical printing process, such as a photographic printing process using water-based ink or solvent ink including oil-based ink, an offset printing process using general ink or UV ink, or a photogravure printing process, etc. Furthermore, the print fabric 330 is made of a transparent material to allow the desired advertisement to be clearly printed on the print fabric 330 and to allow incident rays striking the retroreflective sheet 310 to be smoothly reflected.

The print fabric 330 has thereon the printing layer on which the advertisement is printed through the above-mentioned typical printing process, such as a photographic printing process using water-based ink or solvent ink including oil-based ink, an offset printing process using general or UV ink, or a photogravure printing process, etc.

In the print fabric 330 on which the advertisement is printed a printed fabric is attached to the upper surface of the retroreflective sheet 310 by a typical coating presser. An offset or photogravure printed fabric is attached to the upper surface of the retroreflective sheet 310 through the typical high frequency or ultrasonic bonding process.

Preferably, in the advertising sheet 300 with the advertisement printed using an offset or photogravure printing process, the reinforced fabric 320, the retroreflective sheet 310 and the print fabric 330 are sequentially layered and are simultaneously cut using a high frequency cutting process into a desired shape, and are bonded together.

In the advertising sheet 300 according to the first embodiment, an upper surface of the print fabric 330, on which the advertisement is printed is preferably coated with a transparent coating film 340 by the typical coating presser. The transparent coating film 340 prevents the ink of the printed advertisement from transforming and deteriorating thus enhancing the expected life span of the advertising sheet 300. In a detailed description, if the advertisement is printed on the upper surface of the print fabric 330 though the photographic printing process using water-based ink, the upper surface of the print fabric 330 is preferably coated with the transparent coating film 340. However, if the advertisement is printed on the upper surface of the print fabric 330 though a photographic printing process using solvent ink including oil-based ink, an offset printing process using general or UV ink, or a photogravure printing process, the upper surface of the print fabric 330 may not be coated with the transparent coating film 340.

A method for manufacturing the advertising sheet 300 of the present invention having the above-mentioned structure will be described herein below.

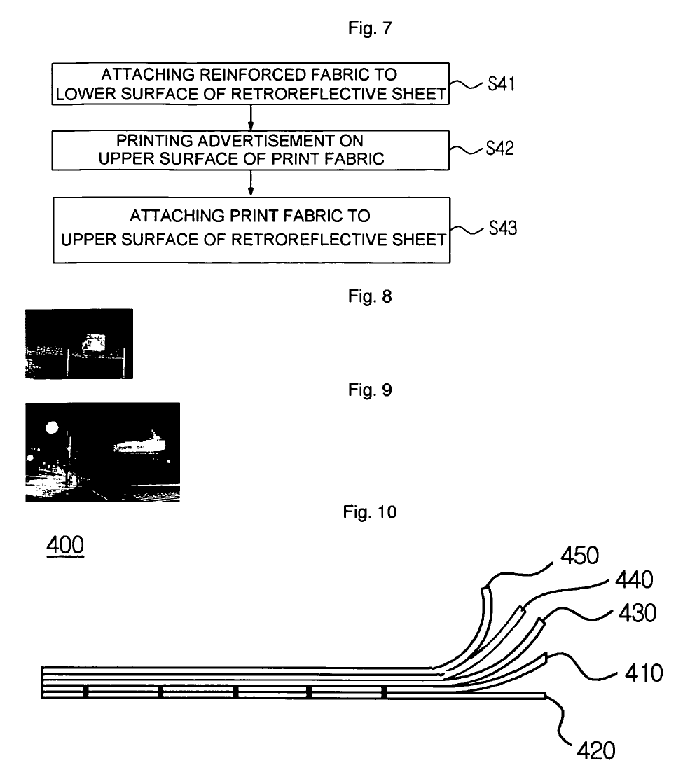

FIG. 7 is a block diagram showing the method for manufacturing the advertising sheet 300 of FIG. 4. Referring to FIGS. 4 through 7, the piece of retroreflective sheet 310 having an appropriate width for advertising or the retroreflective sheet 310, wound into a roll, is prepared.

Thereafter, the reinforced fabric 320 is attached to the lower surface of the retroreflective sheet 310 through the typical high frequency or ultrasonic bonding process at step S41. When moisture or water undesirably enters between the retroreflective sheet 310 and the reinforced fabric 320, the moisture or water must stay in limited portions between them. To achieve the above-mentioned purpose, the reinforced fabric 320 is attached to the retroreflective sheet 310 such that the junction parts between them are spaced apart from each other at predetermined intervals, for example, the junction parts between them may form the four-way consecutive pattern with the regular intervals. The bonding of the reinforced fabric 320 to the lower surface of the retroreflective sheet 310 through the high frequency or ultrasonic bonding process prevents the retroreflective sheet 310 from sagging down.

After the step S41 is accomplished the desired advertisement is printed on the upper surface of the print fabric 330 through the photographic printing process using water-based ink or solvent ink including oil-based ink, or the offset or photogravure printing process at step S42. For example, the advertisement is printed by a photographic printer using water-based ink or solvent ink including oil-based ink, an offset printer using general or UV ink, or a photogravure printer. Thereafter, the print fabric 330 with the advertisement is dried over a predetermined period of time. Then, the advertisement is firmly printed on the print fabric 330 while the ink permeates into the print fabric 330. Thereafter, the print fabric 330 is attached to the upper surface of the retroreflective sheet 310 with the reinforced fabric 320 at step S43, thus completing the advertising sheet 300. At this time, when the advertisement is printed on the print fabric 330 through the photographic printing process, the print fabric 330 is attached to the upper surface of the retroreflective sheet 310 by the typical coating presser. Alternatively, when the advertisement is printed on the print fabric 330 through the offset or photogravure printing process, the print fabric 330 is attached to the upper surface of the retroreflective sheet 310 through the high frequency or ultrasonic bonding process.

Preferably, in the case of using the offset or photogravure printing method, the reinforced fabric 320, the retroreflective sheet 310 and the print fabric 330 are sequentially layered and are simultaneously cut using a high frequency cutting process into a desired shape, and are bonded together, thus completing the advertising sheet 300.

If the advertisement is printed on the upper surface of the print fabric 330 though the photographic printing process using the water-based ink, the upper surface of the print fabric 330 is preferably coated with the transparent coating film 340 by the typical coating presser, before the print fabric 330 is attached to the upper surface of the retroreflective sheet 310. Alternatively, after the print fabric 330, on which the advertisement is printed with water-based ink, is directly attached to the upper surface of the retroreflective sheet 310, the upper surface of the print fabric 330 may be coated with the transparent coating film 340 by a typical coating presser.

The advertising sheet 300 of the present invention can be used in various mediums for advertising, such as indoor and outdoor placards, indoor and outdoor banners, advertising boards and wrapping advertisements for buses, printed materials, posters, blinds for construction sites, blinds for fences, shelter advertising at bus stations, outdoor advertising and wrapping advertising on subways, POP (point of purchase) advertising, traffic safety signs, labels for vessels, signboards, roof advertising, ground advertising boxes for vessels, mouse pads, fancy goods, pictures, fashion goods, bags, shoes, guide signs, and safety products, etc.

FIGS. 8 and 9 are pictures comparatively showing the advertising sheet 300 of FIG. 4 and typical advertising sheets. As shown in FIGS. 8 and 9, the advertising sheet 300 of the present invention reflects incident rays day and night. Accordingly, the advertising sheet 300 is markedly superior in legibility in comparison with different advertising sheets. Furthermore, due to the action of retroreflective rays, the advertising sheet 300 can be easily distinguished from different objects even at a long distance, thus increasing the visibility of the advertising. When the advertising sheet 300 is used on the advertising board of bus, a bus station or an outer surface of a subway, the advertising sheet 300 is useful to prevent traffic accidents and safety hazards. In addition, the advertising sheet 300 of the present invention has the micro-prism retroreflective sheet 310. Therefore, the advertising sheet 300 has higher brightness and superior three-dimensional effect in comparison with conventional reflective sheets. Moreover, the advertising sheet 300 of the present invention gracefully and clearly expresses the colors of the advertisements in comparison with conventional reflective sheets. Furthermore, the advertising sheet 300 has popular appeal due to its inexpensive price.

An advertising sheet 400 according to a second embodiment of the present invention is provided by the direct printing method. In detail, the advertising sheet 400 is manufactured through a photographic printing process using water-based ink. FIG. 10 is a perspective view of the advertising sheet 400, according to a second embodiment of the present invention.

As shown in FIG. 10, the advertising sheet 400 according to the second embodiment of the present invention includes a retroreflective sheet 410 which has a micro-prism reflective surface on a lower surface thereof. The advertising sheet 400 further includes a reinforced fabric 420 which is attached to the lower surface of the retroreflective sheet 410 to serve as a reinforcement and to allow for a smooth reflection on the reflective surface 410. The advertising sheet 400 further includes a chemical layer 430 which is applied to an upper surface of the retroreflective sheet 410, and a printing layer 440 which is provided on an upper surface of the chemical layer 430, with an advertisement printed with water-based ink on the printing layer 440.

The retroreflective sheet 410 and the reinforced fabric 420 have the same structures and functions as those of the retroreflective sheet 310 and the reinforced fabric 320 of the first embodiment, respectively. The chemical layer 430 has a function of allowing water-based ink to be easily fixed on the retroreflective sheet 410. The chemical layer 430 is made of various kinds of marketed chemicals for printing. The chief ingredient among the chemicals for printing is urethane. The chemical layer 430 is applied to the upper surface of the reflective sheet 410 in a thickness of about 0.3˜0.6 μm.

Thereafter, the chemical layer 430 is treated with heat at about 70˜100° C. However, both the thickness of the chemical layer 430 and the temperature of the heat treatment may be changed according to the kind of chemical for printing without being limited to the above-mentioned values. The printing layer 440 has the advertisement which is printed on the upper surface of the chemical layer 430 through the photographic printing process using the water-based ink.

In the advertising sheet 400 according to the second embodiment, an upper surface of the printing layer 440 is preferably coated with a transparent coating film 450 by the typical coating presser. The transparent coating film 450 prevents the ink of the printed advertisement from transforming and deteriorating, thus extending the expected life span of the advertising sheet 400.

A method for manufacturing the advertising sheet 400 of the present invention having the above-mentioned structure will be described herein below.

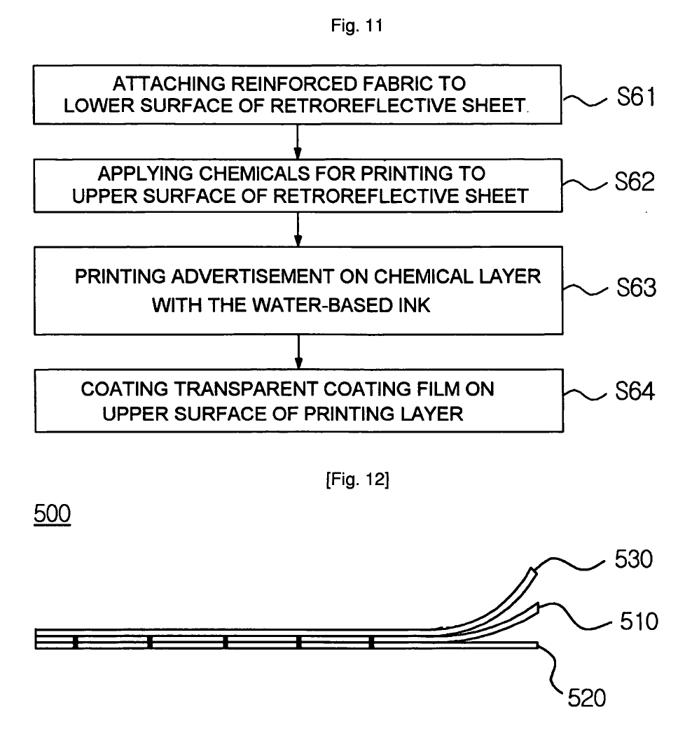

FIG. 11 is a block diagram showing the method for manufacturing the advertising sheet 400 of FIG. 10. Referring to FIGS. 10 and 11, the retroreflective sheet 410, which has an appropriate width for advertising and is wound into a roll, is prepared. Thereafter, the reinforced fabric 420 is attached to the lower surface of the retroreflective sheet 410 through the typical high frequency or ultrasonic bonding process at step S61. When moisture or water undesirably enters between the retroreflective sheet 410 and the reinforced fabric 420, the moisture or water must stay in limited portions between them. To achieve the above-mentioned purpose, the reinforced fabric 420 is attached to the retroreflective sheet 410 such that the junction parts between them are spaced apart from each other at predetermined intervals, for example, the junction parts between them may form a four-way consecutive pattern at regular intervals. The bonding of the reinforced fabric 420 to the lower surface of the retroreflective sheet 410 through the high frequency or ultrasonic bonding process prevents the retroreflective sheet 410 from sagging down.

At step S62, the chemicals for printing are applied to the upper surface of the retroreflective sheet 410 in a thickness of about 0.3˜0.6 μm, prior to being treated with heat of about 70˜100° C., thus forming the chemical layer 430 capable of allowing the water-based ink to be easily fixed on the retroreflective sheet 410. Thereafter, the advertisement is printed on the upper surface of the chemical layer 430 through the photographic printing process using the water-based ink to form the printing layer 440 at step S63. Preferably, the upper surface of the printing layer 440 is coated with a transparent coating film 450 by a typical coating presser at step S64.

The advertising sheet 400 of the present invention solves the problems of conventional advertising sheets in which, because advertisements cannot be directly printed on reflective sheets, processes of manufacturing the advertising sheets are complicated. As a result, the advertising sheet 400 of the present invention increases work efficiency.

An advertising sheet 500 according to a third embodiment of the present invention is provided by the direct printing method. In detail, the advertising sheet 500 is manufactured through a photographic printing process using solvent ink including oil-based ink or through a silk printing process using silk ink. FIG. 12 is a perspective view of the advertising sheet 500, according to a third embodiment of the present invention.

As shown in FIG. 12, the advertising sheet 500 according to the third embodiment includes a micro-prism retroreflective sheet 510 which has a micro-prism reflective surface on a lower surface thereof. The advertising sheet 500 further includes a reinforced fabric 520 which is attached to the lower surface of the retroreflective sheet 510 to serve as a reinforcement and to allow for a smooth reflection on the reflective surface 510. The advertising sheet 500 further includes a printing layer 530 which is provided on an upper surface of the retroreflective sheet 510, with an advertisement printed on the printing layer 530 with silk ink or solvent ink including oil-based ink.

The retroreflective sheet 510 and the reinforced fabric 520 have the same structures and functions as those of the retroreflective sheet 310 and the reinforced fabric 320 of the first embodiment, respectively. The printing layer 530 has the advertisement which is printed on the upper surface of the retroreflective sheet 510 through the photographic printing process using solvent ink including oil-based ink, or through the silk printing process using silk ink which is transparent ink.

To manufacture the advertising sheet 500 according to the third embodiment, the reinforced fabric 520 is attached to the lower surface of the retroreflective sheet 510, in the same manner as that described for the step S61 of the method for manufacturing the advertising sheet 400 according to the second embodiment, as shown in FIG. 11. Thereafter, the advertisement is printed on the upper surface of the retroreflective sheet 510 with silk ink or solvent ink including oil-based ink, thus completing the advertising sheet 500. Preferably, an upper surface of the printing layer 530 is coated with a transparent coating film through a typical coating presser.

### Industrial Applicability

The preferred embodiments of the advertising sheet of the present invention and the methods for manufacturing the same have been disclosed for illustrative purposes with reference to the accompanying drawings, but are not limited to the present invention.

Those skilled in the art will appreciate that various modifications, additions and substitutions are possible, without departing from the scope and spirit of the invention as disclosed in the accompanying claims.

1. An advertising sheet, comprising:
a micro-prism retroreflective sheet having a micro-prism reflective surface on a lower surface thereof;
a reinforced fabric attached to the lower surface of the micro-prism retrore flective sheet to serve as a reinforcement and to allow for a smooth reflection on the micro-prism reflective surface; and
a print fabric attached to an upper surface of the micro-prism retroreflective sheet, with a printing layer, on which an advertisement is printed, provided on an outer surface of the print fabric.

2. An advertising sheet, comprising:
a micro-prism retroreflective sheet having a micro-prism reflective surface on a lower surface thereof;
a reinforced fabric attached to the lower surface of the micro-prism retroreflective sheet to serve as a reinforcement and to allow for a smooth reflection on the micro-prism reflective surface;
a chemical layer applied to-an upper surface of the micro-prism retroreflective sheet to allow a water-based ink to be easily fixed on the micro-prism retroreflective sheet; and
a printing layer provided on the chemical layer, with an advertisement printed with water-based ink on the printing layer.

3. An advertising sheet, comprising:
a micro-prism retroreflective sheet having a micro-prism reflective surface on a lower surface thereof;
a reinforced fabric attached to the lower surface of the micro-prism retroreflective sheet to serve as a reinforcement and to allow for a smooth reflection on the micro-prism reflective surface; and
a printing layer provided on an upper surface of the micro-prism retroreflective sheet, with an advertisement printed on the printing layer with a silk ink or a solvent ink including an oil-based ink.

4. The advertising sheet according to claim 1, further comprising: a transparent coating film covering an outer surface of the printing layer.

5. The advertising sheet according to claim 1, wherein the upper and lower surfaces of the micro-prism retroreflective sheet are treated using a UV (ultra-violet) coating process.

6. A method for manufacturing an advertising sheet which comprises a micro-prism retroreflective sheet having a micro-prism reflective surface on a lower surface thereof; a reinforced fabric attached to the lower surface of the micro-prism retroreflective sheet to serve as a reinforcement and to allow for a smooth reflection on the micro-prism reflective surface; a chemical layer applied to an upper surface of the micro-prism retroreflective sheet to allow a water-based ink to be easily fixed on the micro-prism retroreflective sheet; and a printing layer provided on the chemical layer, with an advertisement printed with water-based ink on the printing layer, comprising the steps of:
attaching the reinforced fabric to the lower surface of the micro-prism retroreflective sheet;
printing the advertisement on the upper surface of the print fabric through the photographic, offset or photogravure printing process, and drying the print fabric with the advertisement; and
attaching the lower surface of the print fabric to the upper surface of the micro-prism retroreflective sheet with the reinforced fabric attached to the lower surface of the micro-prism retroreflective sheet, thus completing the advertising sheet.

7. A method for manufacturing an advertising sheet which comprises: a micro-prism retroreflective sheet having a micro-prism reflective surface on a lower surface thereof; a reinforced fabric attached to the lower surface of the micro-prism retroreflective sheet to serve as a reinforcement and to allow for a smooth reflection on the micro-prism reflective surface; a chemical layer applied to an upper surface of the micro-prism retroreflective sheet to allow a water-based ink to be easily fixed on the micro-prism retroreflective sheet; and a printing layer provided on the chemical layer, with an advertisement printed with water-based ink on the printing layer, comprising the steps of:
attaching the reinforced fabric to the lower surface of the micro-prism retroreflective sheet;
applying the chemicals for printing to the upper surface of the micro-prism retroreflective sheet to form the chemical layer capable of allowing the water-based ink to be easily fixed on the micro-prism retroreflective sheet; and
printing the advertisement on the chemical layer with the water-based ink, thus completing the advertising sheet.

8. The method according to claim 7, further comprising the step of: coating a transparent coating film on a printing layer produced by printing the advertisement on the chemical layer with the water-based ink.

9. A method for manufacturing an advertising sheet which comprises a micro-prism retroreflective sheet having a micro-prism reflective surface on a lower surface thereof; a reinforced fabric attached to the lower surface of the micro-prism retroreflective sheet to serve as a reinforcement and to allow for a smooth reflection on the micro-prism reflective surface; a chemical layer applied to an upper surface of the micro-prism retroreflective sheet to allow a water-based ink to be easily fixed on the micro-prism retroreflective sheet; and a printing layer provided on the chemical layer, with an advertisement printed with water-based ink on the printing layer, comprising the steps of:
attaching the reinforced fabric to the lower surface of the micro-prism retroreflective sheet; and
printing the advertisement on the upper surface of the micro-prism retroreflective sheet with silk ink or solvent ink including oil-based ink, thus completing the advertising sheet.

10. The advertising sheet according to claim 2, further comprising: a transparent coating film covering an outer surface of the printing layer.

11. The advertising sheet according to claim 2, wherein the upper and lower surfaces of the micro-prism retroreflective sheet are treated using a UV (ultra-violet) coating process.

12. The advertising sheet according to claim 3, further comprising: a transparent coating film covering an outer surface of the printing layer.

13. The advertising sheet according to claim 3, wherein the upper and lower surfaces of the micro-prism retroreflective sheet are treated using a UV (ultra-violet) coating process.
